(19) United States
(12) Patent Application Publication
(10) Pub. No.: US 2026/0366902 A1
(43) Pub. Date: Nov. 19, 2026

(54) WASTE MANAGEMENT SYSTEM

(71) Applicant: ZTERS Inc., Houston, TX (US)

(72) Inventors: Dejan Dramicanin, Belgrade (RS); Marko Mihailovic, Mladenovac (RS); Vladimir Vucicevic, Belgrade (RS); Branko Karaklajic, Belgrade (RS)

(73) Assignee: ZTERS Inc., Houston, TX (US)

(21) Appl. No.: 19/673,192

(22) Filed: May 11, 2026

Related U.S. Application Data
(60) Provisional application No. 63/804,269, filed on May 12, 2025.

(51) Int. Cl. G01F 23/292; G06T 7/00; G06V 10/74

(52) U.S. Cl. CPC G01F 23/292; G06T 7/0002; G06V 10/761; G06T 2207/30168

(57) ABSTRACT

A system for determining a fullness state of a container includes a sensor device with one or more content sensors configured for collecting data informative of a fullness state of a container. The system collects data informative of a current fullness state of a container; executes a similarity analysis to assess changes in the fullness state of the container; and transmits data informing on changes to the fullness state of the container based on results of the similarity analysis. A weighted fullness estimate of a fill state of the container is generated based on a first fullness assessment made via data captured by a first content sensor and a second fullness assessment made via data captured by a second content sensor, with weights given to the first and second fullness assessments based on current obstruction parameters and historical confidence factors of the respective content sensors.

### FIELD OF THE INVENTION

The present invention relates generally to container management, particularly in the field of waste management, for systems and methods of monitoring container fill levels and managing waste removal from containers.

### BACKGROUND OF THE INVENTION

Conventionally, waste removal is completed on a standardized schedule in which an entity responsible for waste removal visits a site with a waste container on a recurring schedule. This occurs regardless of the fill state of the waste container. As such, there may be occasions when the waste container is not full and not in urgent need of emptying. On other occasions, the waste container may reach maximum capacity far in advance of a scheduled waste removal, with the container remaining ineffective for receiving further waste until the scheduled removal of waste currently in the container. Conventional practices thus present inefficiencies in that scheduled waste removal may result in wasted resources at sites where there is a lesser need for waste removal while sites with a greater need for waste removal remain unattended. There is thus a need for improvements in managing waste removal.

### SUMMARY OF THE INVENTION

A system for determining a fullness state of a container may comprise a sensor device comprising one or more content sensors, a processor, memory accessible by the processor, program instructions and data stored in the memory, and a network adapter. The one or more content sensors are configured for collecting data informative of a fullness state of a container, and the network adapter is configured for transmitting data collected by the one or more content sensors to a network for delivery to a server.

The processor is configured to collect data informative of a current fullness state of a container via the one or more content sensors, and execute a similarity analysis comparing the collected data informative of the current fullness state of the container and data stored in the memory informative of a prior fullness state of the container. If there is determined a difference between the current fullness state of the container and the prior fullness state of the container in excess of a threshold amount, the processor transmits the collected data informative of the current fullness state of the container to the network via the network adapter. If there is determined a difference between the current fullness state of the container and the prior fullness state of the container not in excess of a threshold amount, the processor forgoes transmission of the collected data informative of the current fullness state of the container.

The sensor devices may comprise one or more content sensors configured to capture data on the content of a container and one or more trigger sensors configured to output a trigger signal to the processor upon detecting a trigger event. The content sensors may be chosen from: a camera; a time-of-flight sensor; and a radar sensor. The trigger sensors may be chosen from: a magnetometer; an ambient light sensor; and a temperature sensor.

The processor may be further configured to collect data informative of a current fullness state of a container via the one or more content sensors upon receiving a trigger signal for triggering data collection. The processor may receive trigger signals from the trigger sensors and/or programmed instructions stored at the memory that are configured to trigger data collection by the one or more content sensors on a predetermined schedule.

The processor may be further configured, when collecting data informative of a current fullness state of a container via the one or more content sensors, to determine if that data collection was performed based on receipt of a trigger signal from a trigger sensor. If data informative of a current fullness state of a container was collected not on the basis of receipt of a trigger signal from a trigger sensor, then the processor may execute the similarity analysis. If the data informative of a current fullness state of a container was collected on the basis of receipt of a trigger signal from a trigger sensor, the processor may forgo the similarity analysis and transmit the collected data informative of the current fullness state of the container to the network via the network adapter.

The processor may be configured to execute a similarity analysis comprising one or more analyses chosen from: a pixel-wise difference analysis; an image down sampling & mean brightness difference analysis; a histogram-based comparison; and an edge detection & structural comparison.

The processor may be further configured to update data stored in the memory to record the collected data informative of the current fullness state of the container for use in future similarity analyses as data informative of a prior fullness state of the container.

A system for determining a fullness state of a container may comprise a processor, memory accessible by the processor, program instructions and data stored in the memory. The processor may be configured to generate a first fullness estimate of the container based on first content data informative of a fullness state of the container, as collected by a first content sensor; generate a second fullness estimate of the container based on second content data informative of a fullness state of the container, as collected by a second content sensor; and generate a weighted fullness estimate of the container as a weighted function of the first fullness estimate and the second fullness estimate, in which the first fullness estimate is assigned a first weight and the second fullness estimate is assigned a second weight.

The processor may be further configured to generate a first obstruction factor representing reliability of the first content sensor; generate a second obstruction factor representing reliability of the second content sensor; calculate the first weight assigned to the first fullness estimate based on the first obstruction factor; and calculate the second weight assigned to the second fullness estimate based on the second obstruction factor.

The processor may be further configured to generate the first fullness estimate based on first content data collected by a cameras as the first content sensor; generate the second fullness estimate based on second content data collected by a time-of-flight sensor as the second content sensor; generate the first obstruction factor representing a reliability of the camera by analyzing the quality and consistency of image data captured by the camera via one or more analyses chosen from: blur detection; dynamic region analysis; and occlusion coverage estimation; and generate the second obstruction factor representing a reliability of the time-of-flight sensor by analyzing distance captured by the time-of-flight sensor via one or more analyses chosen from: an invalid measurement ratio analysis; a static distance pattern analysis; and a depth variance analysis.

The processor may be further configured to generate a first historical confidence factor representing historical confidence of the first content sensor in yielding accurate fullness estimates; generate a second historical confidence factor representing historical confidence of the second content sensor in yielding accurate fullness estimates; calculate the first weight assigned to the first fullness estimate based on the first historical confidence factor; and calculate the second weight assigned to the second fullness estimate based on the second historical confidence factor.

The processor may be further configured to generate the weighted fullness estimate of the container based pre-programmed functions, wherein a first weight (W1) assigned to a first fullness estimate (F1) is calculated as a function of a first obstruction factor (O1) generated relative to the first content sensor, a second obstruction factor (O2) generated relative to the second content sensor, and a first historical confidence factor representing historical confidence of the first content sensor; and a second weight (W2) assigned to the second fullness estimate (F2) is calculated as a function of the first obstruction factor (O1) generated relative to the first content sensor, the second obstruction factor (O2) generated relative to the second content sensor, and a second historical confidence factor representing historical confidence of the second content sensor.

The processor may be further configured to determine a difference between the first fullness assessment and the second fullness assessment and, if the difference exceeds a predetermined threshold difference, generate a discrepancy flag.

The process may be further configured to generate a third fullness estimate of the container based on third content data informative of a fullness state of the container, as collected by a third content sensor; and generate the weighted fullness estimate of the container as a weighted function of the first fullness estimate, the second fullness estimate and the third fullness estimate, in which the third fullness estimate is assigned a third weight.

The processor may be further configured to: generate a first obstruction factor representing reliability of the first content sensor; generate a second obstruction factor representing reliability of the second content sensor; generate a third obstruction factor representing reliability of the third content sensor; calculate the first weight assigned to the first fullness estimate based on the first obstruction factor; calculate the second weight assigned to the second fullness estimate based on the second obstruction factor; and calculate the third weight assigned to the third fullness estimate based on the third obstruction factor.

The processor may be further configured to generate a first historical confidence factor representing historical confidence of the first content sensor in yielding accurate fullness estimates; generate a second historical confidence factor representing historical confidence of the second content sensor in yielding accurate fullness estimates; generate a third historical confidence factor representing historical confidence of the third content sensor in yielding accurate fullness estimates; calculate the first weight assigned to the first fullness estimate based on the first historical confidence factor; calculate the second weight assigned to the second fullness estimate based on the second historical confidence factor; and calculate the third weight assigned to the third fullness estimate based on the third historical confidence factor.

The processor may be further configured to generate the weighted fullness estimate of the container based on pre-programmed functions wherein a first weight (W1) assigned to the first fullness estimate (F1) is calculated as a function of a first obstruction factor (O1) generated relative to the first content sensor, a second obstruction factor (O2) generated relative to the second content sensor, a third obstruction factor (O3) generated relative to the third content sensor, and a first historical confidence factor representing historical confidence of the first content sensor; a second weight (W2) assigned to the second fullness estimate (F2) is calculated as a function of the first obstruction factor (O1) generated relative to the first content sensor, the second obstruction factor (O2) generated relative to the second content sensor, the third obstruction factor (O2) generated relative to the third content sensor, and a second historical confidence factor representing historical confidence of the second content sensor; and a third weight (W3) assigned to the third fullness estimate (F3) is calculated as a function of the first obstruction factor (O1) generated relative to the first content sensor, the second obstruction factor (O2) generated relative to the second content sensor, a third obstruction factor (O3) generated relative to the third content sensor, and a third historical confidence factor representing historical confidence of the third content sensor.

The processor may be further configured to determine differences between at least two of the first fullness assessment, the second fullness assessment, and the third fullness assessment and, if the difference exceeds a predetermined threshold difference, generate a discrepancy flag.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1A is a front perspective view of one example of a sensor device for systems according to the present invention.

FIG. 1B is a front elevation view of the sensor device in FIG. 1A.

FIG. 1C is a rear elevation view of the sensor device in FIG. 1A.

FIG. 2 is a block diagram showing operational components of the sensor device in FIG. 1A.

FIG. 3 is an example of a content assessment process executable by the sensor device in FIG. 1A.

FIG. 4 is a block diagram showing a weighted fusion analysis for use with data collected by the sensor device in FIG. 1A.

FIG. 5 is a block diagram for a modeling process for training systems according to the present invention.

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of container monitoring systems that integrate internet-of-things (IoT) enabled devices, multi-sensor data fusion, and AI-driven analytics. Systems according to the present invention may combine multiple sensor data collection, real-time environmental adaptation, and a weighted fusion algorithm to enable measurement of container fill levels, detection and classification of varying material types, and detection of material removal events. Systems according to the present invention may operate autonomously with minimal maintenance and high efficiency for long-term deployment. While examples herein address monitoring and removal of waste materials from waste containers, systems according to the present invention are not limited to such uses and may be used to monitor fullness states and removal events for other material types.

Systems according to the present invention are inclusive of one or more waste management servers and one or more waste monitoring sensor devices. Each sensor device is adapted for signal communication with at least one server for transmitting data collected at the sensor device informing on a fullness state of a container, and each server is adapted for coordinating removal of material from containers that are determined to be in need of content removal.

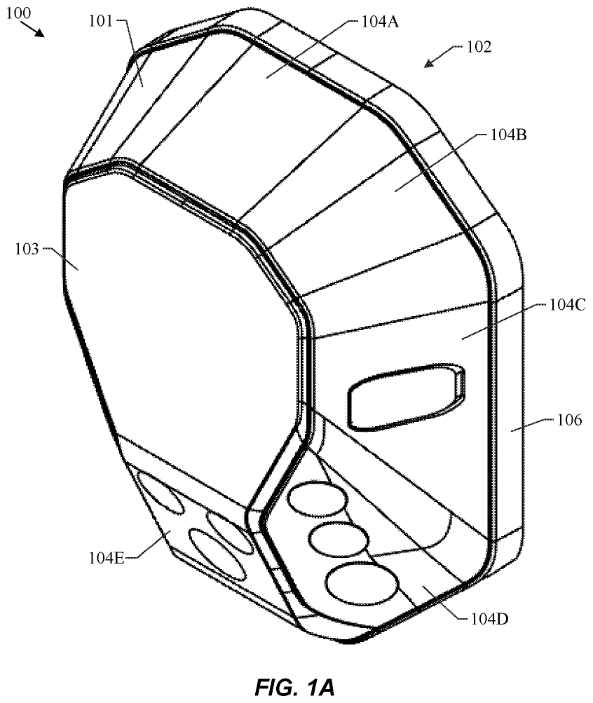

FIGS. 1A-1C show an example of a waste sensor device 100 according to the present invention. In the illustrated example, the sensor device 100 has a device body 101 with a rear surface 102, an opposing front surface 103, a number of peripheral surfaces 104 extending between the front and rear surfaces, and a number of windows 105 enclosed by transparent surfaces for positioning of one or more optical sensors (e.g., cameras, with flash sources; laser time-of-flight (ToF) distance meters; ambient light sensors; etc.).

The rear surface 102 is adapted for attachment to an interior surface of a waste container. In the illustrated example, the rear surface 102 is flat for attachment to a flat surface of a container, though it will be understood that the rear surface 102 may be made with other shapes for attachment to container surfaces of corresponding shapes. An internal space of the device body 101 is sealed to the external environment and an enclosure 109A at the rear surface 102 is provided with one or more pressure-equalizing membranes 108 that are adapted to enable air molecules to pass therethrough while preventing water and small particles (e.g., dust) from flowing therethrough (e.g., an IP67 membrane). A pair of trenches 109B/109C are provided in fluid flow communication with the enclosure 109A to enable air flows to the enclosure 109A, the one or more membranes 108, and the internal space of the device body 101. Inclusion of such a membrane 108 enables equalization of air pressure inside the device body 101 with an ambient air pressure external to the device body 101. This enables the sensor device 100 to adapt to changes that may occur in the ambient air pressure, for example, due to meteorological pressure changes in the environment around the sensor device 100 or due to relocation of the sensor device 100 to a location with a different ambient pressure (e.g., a location at a different altitude).

The rear surface 102 may further include one or more mounting mechanisms for releasably securing the sensor device 100 to a container wall, with preference given to mounting mechanisms that enable selective attachment and removal of the sensor device 100. Non-limiting examples of suitable mounting mechanisms include a female fastener (e.g., a threaded blind hole; a keyhole cavity; etc.) adapted for reception of a mating male fastener (e.g., a threaded screw shaft; an enlarged end of a bolt/screw; etc.). In the illustrated example, device body 101 includes a pair of fastener cavities 107A/107B adapted for reception of fastener elements for securing the device body 101 to a surface.

In the illustrated example, the device body 101 is formed with a generally octagonal shape with a sloped peripheral surface 104 provided at each side of the octagon shape. In other examples, the device body 101 may be formed with any other shape having any number of peripheral sides, including, for example, a hexagonal shape, a pentagonal shape, a square shape, a triangular shape, an oval shape, or a circular shape. In some examples there may be a single peripheral surface, such as in a circular shaped device body 101 with a single continuous peripheral surface therearound. In the illustrated example, a perimeter wall 106 is provided around the perimeter of the device body 101, oriented at a right angle) (90° to the rear surface 102, with the peripheral surfaces 104 extending between the perimeter wall 106 and the front surface 103. In other examples, the device body 101 may omit the perimeter wall 106 and the peripheral surfaces 104 may extend entirely from an edge of the front surface 103 to an edge of the rear surface 102.

In the illustrated example, the device body 101 has a first fastener cavity 107A at a first sloping surface 104G and a second fastener cavity 107B at a second sloping surface. The first and second fastener cavities 107A/107B are examples reception spaces formed in the device body 101 for reception of fastener elements for securing the sensor device 100 to a surface—for example, reception of a threaded fastener for passing through the device body 101 and engaging with a mating fastener on a mounting surface (e.g., an interior surface of a waste container). The illustrated example shows the device body 101 with three separate sets of windows 105, with each window set having three windows 105A-105C, including a first grouping of three windows 105A-105C at a lower left sloping peripheral surface 104F, a second grouping of three windows 105A-105C at a lower right sloping peripheral surface 104D, and a third grouping of three windows 105A-105C at a lower central sloping peripheral surface 104E. One or more of the foregoing window sets may be omitted depending on the intended functionality of a specific sensor device 100. For example, in a sensor device 100 intended for monitoring a space only to the left thereof, the central and right window sets may be omitted; in a sensor device 100 intended for monitoring only a space to the right thereof, the central and left window sets may be omitted, and in a sensor device 100 intended for monitoring only a space below thereof, the right and left window sets may be omitted. Sensor devices 100 according to the present invention may be made with any number of windows depending on the types of sensors employed in that device, including a single window or no windows at all.

It is preferable the device body 101 be formed as a single enclosure body as this provides flexibility for configuring the sensor device 100 for an intended use. In some examples, the device body 101 may be made as a “blind” enclosure with no windows. Such a configuration may be used when the sensor device 100 is intended to operate without optical sensors (e.g., no cameras, no laser ToF sensors, no ambient light sensors), instead employing non-optical sensors such as geo-positioning receivers (e.g., Global Navigation Satellite System, GNSS), accelerometers, magnetometers, temperature sensors, and radar sensors. In some examples, the device body 101 may be made with one or more windows at one or more of a left region, a central region, and a right region the device body 100. Such a configuration may be used when the sensor device 100 is intended to operate with one or more optical sensors, such as a camera (with an accompanying flash source), a laser ToF sensor, and an ambient light sensor. A camera positioned at a window in any of the foregoing regions may provide, for example, a diagonal field-of-view (DFOV) angle of 120°, and two or more cameras placed at adjacent regions may be positioned with overlapping fields of view to enable creation of panoramic images, for example, with a horizontal field-of-view (HFOV) angle greater than 180°.

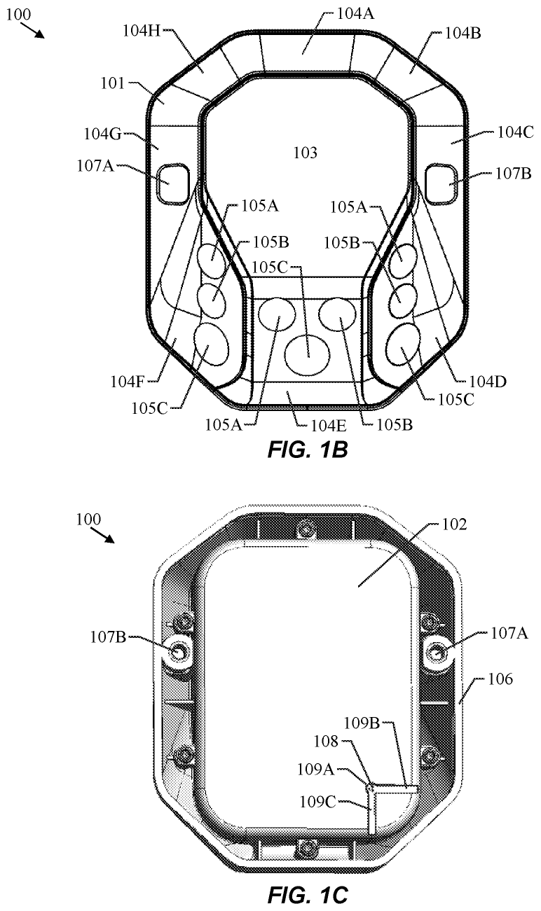

An exemplary block diagram showing components of a sensor device 100 according to the present invention is shown in FIG. 2. As seen in the block diagram, a sensor device 100 may have a number of sensors 110, including trigger sensors for detecting trigger events and content sensors for capturing content data; a memory 111 for storing program instructions and data; a central processing unit (CPU) 112 adapted to read program instructions and data stored at the memory 111 and executing operational routines stored at the memory 111; and a network adapter 113 for communication with a network 200.

Trigger sensors 110 may include sensors adapted to detect movement of a container element (e.g., movement of a container lid or other enclosure) as an indication there has likely been a change to the contents of the container. Non-limiting examples of sensors suitable for use as a trigger sensor 110 include an accelerometer adapted to detect a change in acceleration of a container closure; a magnetometer adapted to detect a change in magnetic field proximate a container closure or a container support surface (e.g., detecting a change in magnetic field proximate a waste container lid, indicating lid opening; or detecting a change in magnetic field proximate forklift pockets of a waste dumpster, indicating insertion of forklift arms of a waste vehicle for waste removal); an ambient light sensor adapted to detect a change in ambient light within the container as indicative that a container closure has been opened; and a temperature sensor adapted to detect a change in temperature within the container as indicative that a container closure has been opened.

Content sensors 110 may include sensors adapted to assess changes to content in a container. Non-limiting examples of sensors suitable for use as a content sensor 110 include a camera (and complimenting flash source) adapted to capture images of content in a container—e.g., a complementary metal-oxide-semiconductor (CMOS) camera; a ToF sensor adapted to measure a distance to content in a container (e.g., an 8×8 grid zone distance sensor); and a radar sensor adapted to measure depth and/or movement of content in the container—e.g., a millimeter wave (mmWave) radar.

Memory 111 is a non-transitory, tangible storage medium capable of retaining and storing data and programmed instructions. Memory 111 stores program instructions that are executed by, and data used and processed by, CPU 112 to perform the functions of the sensor device 100. Memory 11 may include, for example, electronic memory devices, such as random-access memory (RAM), read-only memory (ROM), programmable read-only memory (PROM), erasable programmable read-only memory (EPROM or Flash memory), static random access memory (SRAM), flash memory, etc. As shown in the illustrated example, memory 111 may include sensor data capture routines 114, signal processing routines 115, data aggregation routines 116, data processing routines 117, communication routines 118, signal data 119, physical data 120, aggregate data 121, historical data 122, and an operating system 123. Sensor data capture routines 114 may include routines for the reception and processing of signals from the sensors 110 to form signal data 119. Signal processing routines 115 may include routines to process signal data 119 to form physical data 120. Data aggregation routines 116 may include routines to process physical data 120 to generate aggregate data 121. Data processing routines 117 may include routines to process physical data 120, aggregate data 121, and/or historical data 122. Communication routines 118 may include routines for controlling communication of data via the network adapter 113. Operating system 123 provides instructions for overall system functionality.

CPU 112 executes program instructions to carry out functions of the sensor device 100 and may take any suitable form, including a microprocessor, a microcontroller, a processor in a system-on-chip, etc. Network adapter 113 (e.g., wireless modem; NB-IoT; etc.) interfaces the sensor device 100 with the network 200, which may include any public or proprietary LAN or WAN, including, but not limited to the Internet. Network adapter 113 may be adapted to upload information to the network 200, including all data and information captured by the sensors 110 of the sensor device 100, and may also be adapted to download information from the network 200, for example to enable updates to stored data and routines at the memory 111. Network adapter 113 may include one or multiple different communications devices, including short-range communication devices such as a Near Field Communication (NGC) antenna for communication with user handheld devices for use during activation and reconfiguration of the sensor device 100.

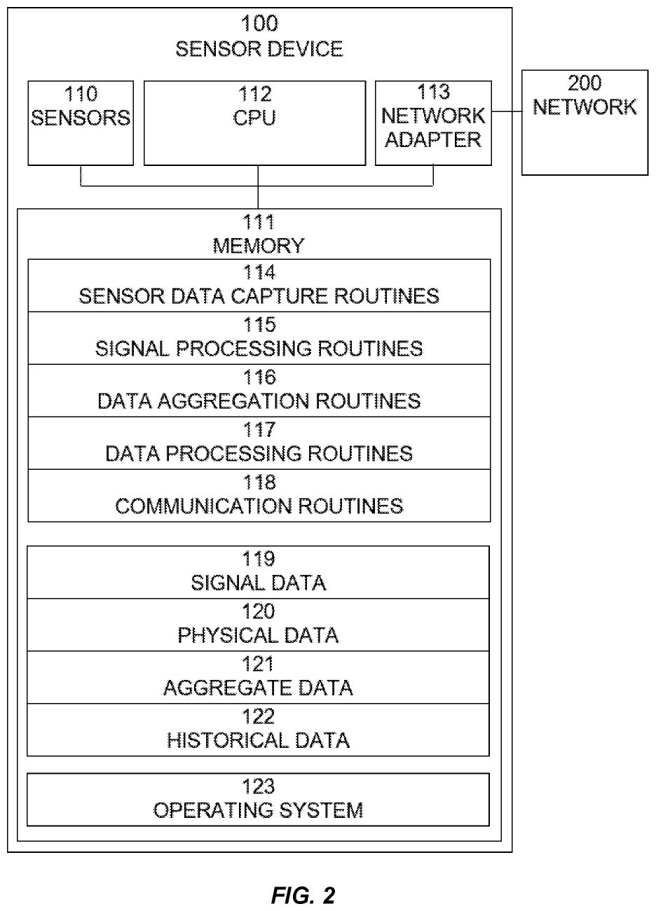

FIG. 3 shows an example of a content assessment process as executed by a sensor device 100 according to the present invention. The sensor device 100 may be powered by an internal power source that may be replaceable and/or rechargeable and the content assessment process may be adapted to reduce wireless communication frequency, preserving battery life while maintaining data integrity, through use of a similarity analysis that leverages low-power on-device processing to decide when data transmission is necessary.

A similarity analysis combines data collected by one or more sensors 110 to assess if there has been a significant change to the container fill level, and limits data transmissions via the network adapted 113 based on the results of the similarity analysis. As one example, a similarity analysis may assess visual changes in container contents between sequential images captured by a camera and/or assess distance measurement changes in container contents between sequential distance measurements captured by a ToF sensor and/or radar sensor, and may cross validate these assessments, to determine if there has been any significant change to the container fill level (e.g., a change in excess of a predetermined threshold). If it is determined that a container's fill level remains substantially unchanged from a prior content assessment process, then it is determined that no actionable change has occurred to the contents of the container and data transmission is either minimized (e.g., minimal transmission to confirm assessment made, though without transmitting data collected by sensors) or altogether omitted to save energy, thereby minimizing energy consumption to prolong battery life and reduce the frequency of replacement or recharging of the battery.

As seen in FIG. 3 the assessment process begins at a step S1 in which a trigger signal is received indicating that a content assessment is needed. In a step S2, one or more content sensors 110 are activated to capture data informing on the content of the container. In a step S3, it is determined if the trigger event originated from a trigger sensor 110. If it is determined that the trigger event originated from a trigger sensor 110 (step S3: YES), then the process proceeds to step S4 and the network adapter 113 transmits data captured by the content sensors 110 (image data and sensor measurement data) to a server via the network 200. If it is determined that the trigger event did not originate from a trigger sensor 110 (step S3: NO), then the process proceeds to step S5 and a similarity analysis is executed to assess if there has been a significant change to the content of the container as compared to data recorded in the memory as “preceding content data”, representing data recorded from the most-immediate prior content assessment. If it is determined that there has been a significant change to the content of the container (step S5: YES), such as an increase in content level beyond a predetermined threshold, then the process proceeds to step S4 and the network adapter 113 transmits data captured by the content sensors 110 to the server via the network 200. After transmitting data to a server (step S4) or if it is determined there has not been a significant change to the content fill level of the container (step S5: NO), the process proceeds to step S6 and stored historical data on the container content is updated to record the data captured by the content sensors 110 in the current content assessment as the “preceding content data” for use in a future similarity analysis. The content assessment process then terminates in a step S7.

A content assessment begins in step S1 upon receipt of a trigger signal. A trigger signal may originate from a trigger sensor 110 that output the trigger signal upon detecting a trigger event or may originate from execution of preprogrammed instructions stored at the memory 111. A trigger sensor 110 may output a trigger signal to the CPU 112 upon detecting an event informative that there was likely a change to the content of the container, such as removal or insertion of waste in a waste container. This may include, for example, detected movement of the container or an element of the container (e.g., container lid or other closure), which indicates a possible change in the content level in the container such that a content assessment should be executed to assess the content thereof. For example, a trigger sensor 110 in the form of an accelerometer may detect a change in acceleration of a container or a container closure; a trigger sensor 110 in the form of a magnetometer may detect a change in magnetic field proximate a container closure; a trigger sensor 110 in the form of an ambient light sensor may detect a change in ambient light within the container; and a temperature sensor may detect a change in temperature within the container-all of which may imply movement of the container or a container closure, which in turn suggests a likely change to the content of the container, such as insertion or removal of waste from a waste container.

Execution of preprogrammed instructions stored at the memory 111 may cause transmission of a signal, for example, based on programmed instructions for scheduled content assessments and/or programmed instructions for content confirmation. Memory 111 may store programmed instructions for execution of content assessments according to a predetermined schedule for content assessments (e.g., 1-5 times a day, equally spaced within predetermined working hours, etc.) to regularly require execution of content assessments even when no trigger signals are received from any trigger sensors 110. Memory 111 may also store programmed instructions to execute a content assessment upon the lapse of a predetermined time interval (e.g., 5 minutes, 10 minutes, etc.) after a prior content assessment. As an example, the sensor device 100 may be programmed such that, upon receiving a trigger signal from a trigger sensor 110 indicating that a waster container was emptied (e.g., movement of the container body as a whole), a primary content assessment may first be executed based on receipt of that trigger signal and, after lapse of a predetermined time interval from completion of the primary content assessment, a second content assessment may then be performed to update the content data on the container, for example, to confirm that the waste removal event was successful in fully emptying the container.

Upon detecting a trigger event, one or more content sensors 110 are activated in step S2 to capture data informing on the content of the container. A camera (and complimenting flash source) may capture images of content in the container; a ToF sensor may measure a distance between the sensor and the top of the content in a container; and a radar sensor may measure a depth of content in the container. The captured content data is stored in the memory 111, at least temporarily until a determination is made whether to transmit the data to a server or may be stored permanently for use in cross-referencing with captured data in subsequent content analyses.

In a step S3 it is determined if the trigger signal that initiated the current content analysis originated form a trigger sensor 110. Trigger sensors 110 are configured to detect circumstances that are determined in advance to present a likelihood of a change to the content in the container, for example, such as the opening of a container closure which may infer insertion of material into the container or the movement of the entire container which may infer emptying of the container. On the other hand, preprogrammed instructions (e.g., programmed content schedule; programmed content confirmations) are configured to initiate a content analysis independent of any activity that would suggest a change to the content in the container. Programmed instructions for transmitting a trigger signal may be executed to ensure there has not been an undetected activity that resulted in a change to the contents in the container, such as assessments made based on programmed content schedule; or to confirm that a presumed content state is accurate, such as assessments made based on programmed content confirmations to confirm that a container is in an empty state after a removal event. It is thus expected that content analyses executed in response to a trigger signal received from a trigger sensor 100 will have a relatively greater likelihood of identifying a change in content level of a container as compared to a relatively lesser likelihood for content analyses executed in response to programmed instructions. Systems according to the present invention may thus be programmed to always transmit content data captured as a result of a trigger signal received from a trigger sensor 110, as this data has a relatively greater likelihood of informing a change in content, whereas greater energy efficiency may be found in conditional reporting of content data captured as a result of a trigger signal originating from execution of a preprogrammed instruction, as this data has a relatively lesser likelihood of informing a change in content. Therefore, if it is determined that the current content analyses was executed based on a trigger signal received from a trigger sensor 110 (step S3, YES), then the process proceeds with mandatory transmission of the content data to a server (step S4); and if it is determined the current content analyses was executed not on the basis of a trigger signal received from a trigger sensor 110 (step S3, NO), inferring execution was instead on the basis of preprogrammed instructions, then the process instead proceeds to execute a similarity assessment (step S5) for conditional transmission of the content data to a server.

Under circumstances of conditional transmission, the process proceeds to step S5 in which a similarity analysis is executed to assess for significant changes to the content in the container. In the similarity analysis, data captured from the current content analysis is compared to data from a prior content analysis to assess if the newly captured data is indicative of a change in the container fill level. Data from the current analysis may be temporarily held in a data buffer of the memory 111 for comparison with data from a prior content analysis as recorded to the memory 111. Preferably, the data from the prior content analysis will be from the most-immediate prior content analysis and may be stored with a label conveying the same, which may be referred to herein as “preceding content data” or the like. Examples of similarity analyses that may be used with systems of the present invention include, though are not limited to: pixel-wise difference analysis; image down sampling & mean brightness difference analysis; histogram-based comparison; edge detection & structural comparison (e.g., using algorithms like Sobel or Canny edge detection for extraction and comparison of structural features).

The similarity analysis results in a computed similarity factor that is compared to a predefined similarity threshold to determined if there has been a significant change to the fill level of the container. If the similarity factor exceeds the similarity threshold, then it is determined there has not been a significant change to the container fill level (e.g., waste level has not increased beyond a predetermined threshold); if the similarity factor does not exceed the similarity threshold, then it is determined there has been a significant change to the container fill level (e.g., waste level has increased beyond the predetermined threshold). If it is determined that there has been a significant change to the container fill level (step S5, YES), then the process proceeds with transmission of the content data to a server (step S4); and if it is determined there has not been a significant change to the container fill level (step S5, NO), then the process proceeds without data transmission to a server, reducing power consumption and network usage.

In circumstances where it is determined either that the content analyses was executed based on a trigger signal received from a trigger sensor 110 (step S3, YES) or a similarity assessment has determined that there has been a significant change to the container fill level (step S5, YES), the process proceeds to step S4 in which the network adapter 113 transmits data captured by the content sensors (full data set, images and sensor measurement data) to a server via the network 200. Following the transmission of data to a server in step S4, or in circumstances where it is determined there has not been a significant change to the container fill level (step S5, No), the process proceeds to step S6 in which data recorded at the memory 111 is updated to store data from the current content analysis, which may have previously been held in temporary memory, and label the same as the “preceding content data”, for cross-reference in a similarity analysis that may be performed in the next content analysis. After updating the data recorded to the memory 111, the process proceeds to step S7, at which time the current content analysis is terminated.

Data transmitted to a server includes captured camera images (e.g., RGB colored images from a CMOS camera); all data captured by each other sensor (8×8 grid distance matrix from ToF laser sensor; depth and motion data from mmWave radar sensor); and metadata. Non-limiting examples of metadata includes timestamps, device identification information, device location data, information on the trigger event that initiated data readings, local environmental conditions for the sensor device, and the like. Device location data may be based on data prestored in the memory 111, or the sensor device 100 may include one or more geo-positioning devices (e.g., Global Navigation Satellite System, GNSS) that provides updated location information for sensor device 100 each time data is transmitted. Systems according to the present invention use a weighted fusion algorithm to dynamically adjust data received from the multiple individual sensors at the sensor device based on real-time conditions to provide increased accuracy in assessing container contents. In addition to detecting a fullness state of a container, systems according to the present invention may use AI-based inferences to enhance object detection, classification, and environmental mapping. Dynamic weighting may be achieved through sensor calibration, environmental adaptation, obstruction parameter influence, and a weighted fusion algorithm. In some examples, these processes may be performed by the CPU 112 at the sensor device 100 based on programming stored in the memory 111. In other examples, these processes may be performed at a server that receives data transmitted across the network 200 by the network adapter 113.

Sensor calibration is automatically performed by the sensor device 100 during installation in a container, establishing baseline performance metrics (e.g., expected accuracy, range, and reliability) without need for manual intervention.

Environmental adaptation is performed through real-time monitoring of environmental conditions around the sensor device 100, including environmental conditions that would influence readings from a given sensor 110 in the sensor device 100. Lighting conditions may be monitored to assess influences on the quality of images captured by image sensors, such as cameras. Monitoring of lighting conditions may include assessing one or more of brightness, contrast, and potential obstructions in the field of view of a camera. Signal interference conditions may be monitored to assess influences that may impact sensor accuracy and/or the quality of measurements made by signal sensors, such as ToF sensors and radar sensors. Monitoring of interference signal conditions may include measuring one or more interference signal conditions, such as noise levels, signal consistencies, and signal strengths; and may also include measuring one or more non-signal conditions that may act upon the sensor device 100, such as those that would influence environmental stability (e.g., vibrations or extreme weather effects). The foregoing are non-limiting examples of environmental conditions that may be monitored for environmental adaptation, preferably with at least one environmental condition monitored for each sensor in the sensor device 100 so that each sensor's reliability may be dynamically scored based on current environmental conditions. Confidence levels of individual sensors 110 may also be assessed by executing redundancy processes that compare data from multiple sensors 110 to check for and identify any discrepancies between data captured by the individual sensors 110.

Obstruction parameter influence is assessed as a real-time obstruction factor, ranging from 0 to 100, representing reliability of sensor measurements under current operating conditions. The obstruction factor is used for automatically adjusting the measurement weighting of a sensor 110 based on detection of obstructions to the sensor 110, such as dirt or debris on a lens or noise signals. An obstruction factor value of 0 represents an unobstructed state, and an obstruction factor value of 100 represents an entirely obstructed state. As an example, if it is determined that a sensor 110 is obstructed (e.g., debris on a camera lens), the obstruction factor may be used to reduce weight given to data received from that sensor 110, shifting greater reliance to data received from other sensors 110, which may include sensors of the same type (e.g., weight shifting from a first camera to a second camera) or sensors of different types (e.g., weight shifting from a camera to a ToF sensor, a radar sensor, etc.). The system may be programmed to trigger a maintenance alert if an obstruction factor reaches a predetermined critical threshold. For example, a maintenance alert may be triggered if it is determined that a sensor 110 has a less than 20% reliability (e.g., an obstruction factor equal to or greater than 80). Optionally, the system may be programmed for a user to selectively adjust the value for a critical threshold that triggers a maintenance alert. In this way, the system is adapted to ensure consistent performance with minimal manual intervention.

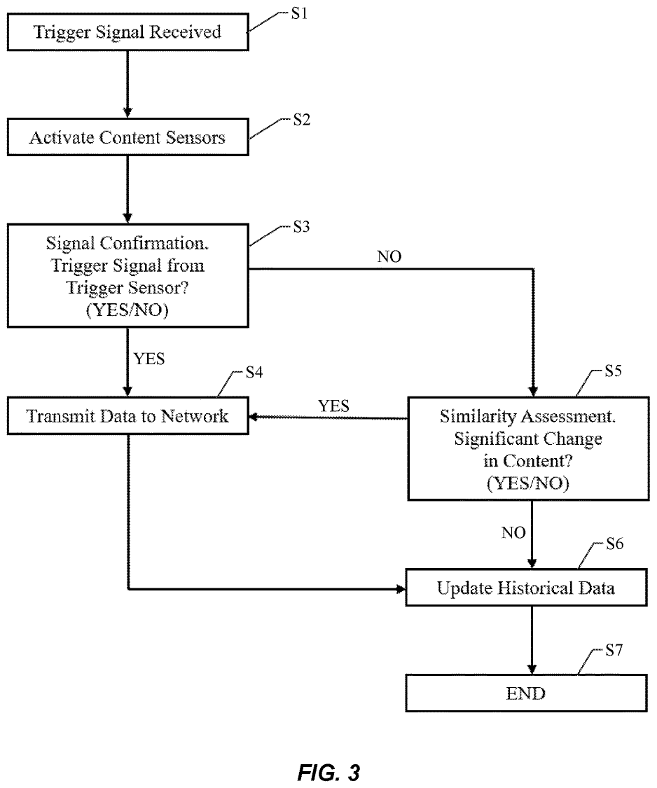

A weighted fusion algorithm effects sensor weighting through real-time calculations that incorporate sensor reliability scores determined for each sensor, as derived from the environmental adaptation and obstruction parameters discussed above, and historical accuracy scores determined from previous sensor performance under similar conditions to adjust the weighting of sensor data when redundant sensor measurements overlap, reducing unnecessary reliance on any single sensor 110. A block diagram of a weighted fusion analysis is shown in FIG. 4. In this example, data inputs are provided from a camera 110A, a ToF sensor 110B, and a mmWave radar sensor 110C with three separate fullness assessments F1, F2, F3 made from the respectively received data.

In a first fullness assessment F1, a fullness state of the container is determined based on image processing of image data captured by the camera 110A alone. The image processing may be made with inferences from an image AI model for fullness detection, which is an image-based model of fullness that may be pre-trained and/or iteratively trained during operation of the system, for example, based on readings from other sensors. In a second fullness assessment F2, a fullness state of the container is determined based on processing of distance data captured by the ToF sensor 110B alone. The processing of distance data may be made by non-AI analytical calculations. In a third fullness assessment F3, a fullness state of the container is determined based on processing of radar data captured by the mm Wave radar camera 110C alone. In a weighted fullness assessment WF, a fullness state of the container is determined using a weighted fusion algorithm to combine the results of two or more of the individual fullness assessments F1, F2 and/or F3, with corresponding historical confidence factors H1, H2 and H3 and corresponding obstruction factors OC (O1), OT (O2) and OR (O3), for a weighted fullness estimate that accounts for varying container conditions. Preferably, each of the first fullness assessment F1, the second fullness assessment F2, the third fullness assessment F3, and the weighted fullness assessment WF are output as a fullness score ranging from 0-100, representing a fullness state of the container (e.g., 0=empty; 100=filled to capacity). Preferably, a discrepancy assessment is also made between each fullness assessment adopted in the weighted fullness assessment to assess for any inconsistencies that may be informative of anomalies such as sensor failure or interference.

As one example, a weighted fusion algorithm that employs two sensors in the weighted fullness assessment WF may combine the results of a first fullness assessment F1 from a first sensor 110A and a second fullness assessment F2 from a second sensor 110B while dynamically adjusting corresponding confidence weights W1 and W2 of the separate assessment results based on obstruction factors of the corresponding sensors calculated in real-time (e.g., OC, OT), as well as data-driven historical confidence factors for the corresponding sensors (H1, H2). The confidence weights W1 and W2 of the individual sensors 110 may be calculated according to the following formulas:

$$W 1 = \frac{( 1 - OC ) \cdot H 1}{( 2 - OC - OT )} \qquad ( 1 )$$

$$W 2 = \frac{( 1 - OT ) \cdot H 2}{( 2 - OC - OT )} \qquad ( 2 )$$

In the foregoing formulas, “W1” represents a confidence weight given to a first sensor 110A; “W2” represents a confidence weight given to the second sensor 110B; “OC” (or “O1”) represents an obstruction factor of the first sensor 110A; “OT” (or “O2”) represents an obstruction factor of the second sensor 110B; “H1” represents a historical confidence factor for the first sensor 110A; and “H2” represents a historical confidence factor for the second sensor 110B.

A camera obstruction factor (OC) may be computed by an obstruction factor estimation in which quality and consistency of image data captured by a camera 110A is analyzed, for example, via blur detection; dynamic region analysis; and occlusion coverage estimation. Blur detection may include assessing image sharpness using metrics such as variance of the Laplacian, with detection of persistent high blur levels being indicative of potential obstruction (e.g., condensation or dirt on the camera lens). Dynamic region analysis may include mapping expected static regions (e.g., container walls) during normal operation and identifying unexpected static regions by detecting areas that remain unchanged across multiple consecutive captured images to the exclusion of the pre-identified static regions, with unexpected static regions being indicative of potential obstructions (e.g., debris or objects blocking the camera lens). Occlusion coverage estimation may include estimating a percentage of a dynamic region, represented by an area of an image that is covered or obstructed by a blurry, low-texture and/or uniform color, which may be indicative of objects blocking the camera lens. Obstruction factor estimation may generate a camera obstruction factor OC value in a range of (0≤OC≤100), which is subsequently normalized to a value in the range of (0≤OC≤1) for use in the confidence weight formulas (1) and (2) addressed above, with “0” representing no obstruction and “1” representing complete obstruction.

A ToF obstruction factor (OT) may be computed by an obstruction factor estimation in which distance data captured by a ToF sensor 110B is assessed, for example, via one or more of computing an invalid measurement ratio; detecting static distance pattern; and depth variance analysis. An invalid measurement ratio may be computed as the proportion of invalid points in the data (e.g., no return signal or out-of-range values), with a higher ratio corresponding to a higher OT score. Static distance pattern analysis may include assessing the data to determine a range of distance readings, with cases in which a large portion of the matrix data shows constant distance values across multiple readings being indicative of a potential obstruction near the sensor. Depth variance analysis may include assessing the variance in measured distance readings, with cases in which there is a low variance in measured distances being indicative of a flat or uniform surface, such as debris or liquid, obstructing the field of view of the sensor. Obstruction factor estimation may generate a ToF obstruction factor OT value in a range of (0≤OT≤100), which is subsequently normalized to a value in the range of (0≤OT≤1) for use in the confidence weight formulas (1) and (2) addressed above, with “0” representing no obstruction and “1” representing complete obstruction.

In application, obstruction factors (OC, OT) are given values in a range of (0≤O≤1), with “0” representing no obstruction and “1” representing complete obstruction; and historical confidence factors (H1, H2) are likewise given values in a range of (0≤H≤1), with “0” representing no confidence and “1” representing complete confidence. The confidence weights (W1, W2) thus yield values in a range of (0≤W≤1), with “0” representing no reliance on that sensor and “1” representing exclusive reliance on that sensor to the exclusion of the other sensor.

The calculated confidence weights W1 and W2 are normalized according to the following formulas:

$$W 1 n = \frac{W 1}{( W 1 + W 2 )} \qquad ( 3 )$$

$$W 2 n = \frac{W 2}{( W 1 + W 2 )} \qquad ( 4 )$$

$$W 1 n + W 2 n = 1 \qquad ( 5 )$$

In the foregoing formulas, the subscript “n” represents “normalized”. The normalized weights are balanced proportionally such that summation of the weighted reliance given to each sensor is equal to unity (e.g., W1+W2=1). In this way, the weighted fullness assessment WF is calculated as a weighted summation of the first fullness assessment F1 and the second fullness assessment F2 according to the following formula:

WF=W1n·F1+W2n·F2 (6)

As another example, a weighted fusion algorithm that employs three sensors in the weighted fullness assessment WF may combine the results of a first fullness assessment F1 from a first sensor 110A, a second fullness assessment F2 from a second sensor 110B, and a third fullness assessment F3 from a third sensor 110C while dynamically adjusting corresponding confidence weights W1, W2 and W3 of the separate assessment results based on obstruction factors of the corresponding sensors calculated in real-time (e.g., OC, OT, OR), as well as data-driven historical confidence factors for the corresponding sensors (H1, H2, H3). The confidence weights W1, W2 and W3 of the individual sensors 110 may be calculated according to the following formulas:

$$W 1 = \frac{( 1 - OC ) \cdot H 1}{( 3 - OC - OT - OR )} \qquad ( 7 )$$

$$W 2 = \frac{( 1 - OT ) \cdot H 2}{( 3 - OC - OT - OR )} \qquad ( 8 )$$

$$W 3 = \frac{( 1 - OR ) \cdot H 3}{( 3 - OC - OT - OR )} \qquad ( 9 )$$

In the foregoing formulas, “W1” represents a confidence weight given to a first sensor 110A; “W2” represents a confidence weight given to the second sensor 110B; “W3” represents a confidence weight given to the third sensor 110C; “OC” (or “O1”) represents an obstruction factor of the first sensor 110A; “OT” (or “O2”) represents an obstruction factor of the second sensor 110B; “OR” (or “O3”) represents an obstruction factor of the third sensor 110C; “H1” represents a historical confidence factor for the first sensor 110A; “H2” represents a historical confidence factor for the second sensor 110B; and “H3” represents a historical confidence factor for the third sensor 110C. The camera obstruction factor (OC) and ToF obstruction factor (OT) may be computed as discussed above. The radar obstruction factor (OR) may be computed by any suitable means. In application, obstruction factors (OC, OT, OR) are given values in a range of (0≤O≤1), with “0” representing no obstruction and “1” representing complete obstruction; and historical confidence factors (H1, H2, H3) are likewise given values in a range of (0≤H≤1), with “0” representing no confidence and “1” representing complete confidence. The confidence weights (W1, W2, W3) thus yield values in a range of (0≤W≤ 1), with “0” representing no reliance on that sensor and “1” representing exclusive reliance on that sensor to the exclusion of the other sensors.

The calculated confidence weights W1, W2 and W3 are normalized according to the following formulas:

$$W 1 n = \frac{W 1}{( W 1 + W 2 + W 3 )} \qquad ( 10 )$$

$$W 2 n = \frac{W 2}{( W 1 + W 2 + W 3 )} \qquad ( 11 )$$

$$W 3 n = \frac{W 3}{( W 1 + W 2 + W 3 )} \qquad ( 12 )$$

$$W 1 n + W 2 n + W 3 n = 1 \qquad ( 13 )$$

In the foregoing formulas, the subscript “n” represents “normalized”. The normalized weights are balanced proportionally such that summation of the weighted reliance given to each sensor is equal to unit (e.g., W1n+W2n+W3n=1). In this way, the weighted fullness assessment WF is calculated as a weighted summation of the first fullness assessment F1, the second fullness assessment F2 and the third fullness assessment F3 according to the following formula:

WF=W1n·F1+W2n·F2+W3n·F3 (14)

A further determination is made for a discrepancy between individual fullness assessments, and if there is found a discrepancy beyond a predetermined threshold difference ΔF (e.g., |F1-F2|≥ΔFa, |F1−F3|≥ΔFb, or |F2−F3|≥ΔFc), then the weighted fullness assessment WF is output and recorded with a discrepancy flag indicating an inconsistency in the results that may be informative that measurements in this assessment are potentially of lesser accuracy for assessing a fullness state of the container and calculating the accuracy of future sensor weightings, and that one of the sensors 110 may be experiencing an operational error requiring manual intervention.

In ideal circumstances, each sensor will have zero obstruction (OC=0; OT=0; OR=0) and complete historical confidence (H1=1; H2=1; H3=1), with all sensors given equal confidence weights (W1=0.5 and W2=0.5; or W1=0.3333, W2=0.3333 and W3=0.3333) for an equally balanced reliance on the fullness assessments (F1, F2, F3) made from the data captured by the respective sensors (110A, 110B, 110C). In a scenario where a two sensor weighted fullness assessment is made, if a first sensor 110A has either a complete obstruction (e.g., OC=1) or no historical confidence (e.g., H1=0), while the other sensor 110B has no obstruction (e.g., OT=0) and complete historical confidence (e.g., H2=1), the first sensor 110A would then be given a null confidence weight (e.g., W1=0) and the second sensor 110B would be given an exclusive confidence weight (e.g., W2 =1). In a scenario where a three-sensor weighted fullness assessment is made, if a first sensor 110A has either a complete obstruction (e.g., OC=1) or no historical confidence (e.g., H1=0), while a second sensor 110B has 50% obstruction (e.g., OT=0.5) and 25% historical confidence (e.g., H2=0.25), and a third sensor 110C has no obstruction (e.g., OR=0) and complete historical confidence (e.g., H3=1), the first sensor 110A would then be given a null normalized confidence weight (e.g., W1n=0), the second sensor 110B would be given a 1/5 normalized confidence weight (e.g., W2n=0.2), and the third sensor 110C would be given a 4/5 normalized confidence weight (e.g., W3n=0.8).

Systems according to the present invention thus enable a concurrent, multi-modal AI approach in which a multi-sensor analysis may be used based on data captured by multiple sensors when the multiple sensors are each determined to have an acceptable weight (e.g., W1>0, W2>0, W3>0), or a single-sensor analysis may instead be used based on data captured by a single sensor when one or more sensors are deemed to have an unacceptable weight while at least one sensor is deemed to have an acceptable weight (e.g., W1=0 and W2>0; W1=0, W2>0, and W3>0; or W1=0, W2=0 and W3>0). If it is determined that all sensors are completely obstructed (OC=1, OT=1, and OR=1), then there is no defined confidence weight for any sensor, it is determined that no content analysis can be made, and an alert is triggered indicating the sensors at this container require maintenance. More practically, provided each sensor is routinely cleaned and kept free of obstructions (OC=0; OT=0; and OR=0), the sensors will be given confidence weights based on their historical confidence rates, with greater reliance placed on data captured from the sensor of relatively greater historical confidence.

In the above formulas, confidence weights W1, W2 and W3 are expressed with a camera obstruction factor (OC) for a camera 110A, a ToF obstruction factor (OT) for a ToF sensor 110B, and a radar obstruction factor (OR) for a mmWave radar 110C. It will be understood that systems according to the present invention are not limited to combinations of sensors chosen only from a camera, a ToF sensor and a mmWave radar, and that obstructions variables OC, OT and OR may instead be replaced by variables such as “O1” for a first obstruction factor for a first sensor, “O2” for a second obstruction factor for a second sensor and “O3” for a third obstruction factor for a third sensor, just as H1 represents a historical confidence factor for a first sensor (e.g., camera 110A in this example), H2 represents a historical confidence factor for a second sensor (e.g., ToF sensor 110B in this example) and H3 represents a historical confidence factor for a third sensor (e.g., mmWave radar sensor 110C in this example). The historical confidence factors H1, H2 and H3 are calculated from stored historical data from previous content assessments for the container and are updated based on long-term reliability and accuracy trends, for example, as a percentage of the accuracy of the respective sensors in having yielded fullness assessments matching a verified fullness state of the container in previous content assessment cycles.

Preferably, content assessment records for past performances include details of any obstruction conditions experienced during the respective assessments, with content assessments made under similar obstruction conditions associated with one another such that each sensor may have specific historical confidence factors H1, H2 and H3 that are based on measurements made under similar obstruction conditions. In this way, when performing a current content assessment, the confidence weights W1, W2 and W3 may be calculated with use of historical confidence factors H1, H2 and H3 based on measurements made under similar obstructions conditions as those determined present in the current content assessment. For example, if a current content analysis is being made under circumstances where a camera is determined to have low blur, no unexpected static regions, though high occlusion coverage, then the confidence factor H1 used in determining the confidence weight W1 may be calculated based on data recorded from past content analyses under these same three circumstances. Similarity, if a current content analysis is being made under circumstances where a ToF sensor is determined to have a low invalid measurement ratio, a high portion of the matrix data showing constant distance values, and a high depth variance, then the confidence factor H2 used in determining the confidence weight W2 may be calculated based on data recorded from past content analyses under these same three circumstances. Likewise, a content analysis made with the mmWave radar will be made with calculation of the confidence weight W3 based on a confidence factor H3 determined from data recorded from past content analyses that were made under similar circumstances as detected for the current content analysis.

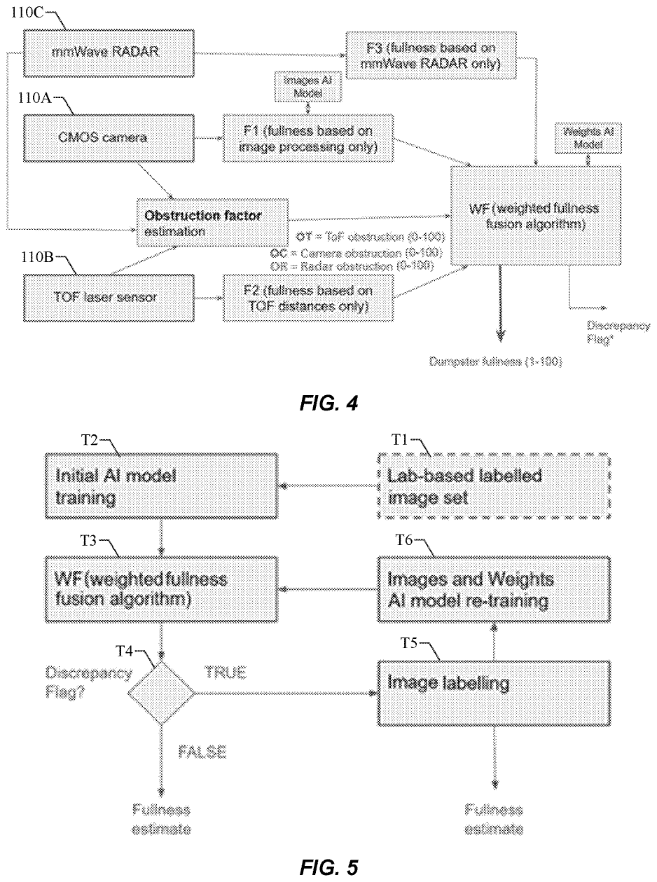

FIG. 5 shows a block diagram for an example of a modeling process for training systems according to the present invention, in an example of a two sensor analysis, with an AI system that may be continuously improved through an iterative self-optimizing feedback loop, leveraging discrepancy detection, human-assisted correction, and model re-training to enhance accuracy. The training process involves at least two models: an image-based AI model responsible for estimating fullness based on images, and a weighted AI Model responsible for dynamically adjusting the contribution of the first fullness assessment F1 (image-based assessment) from a camera and the second fullness assessment F2 (ToF-based assessment) from a ToF sensor in the weighted fullness assessment WF (weighted fusion assessment).

In image-based AI modelling T2, training is done with a labeled image dataset T1 containing controlled images of containers of varying fullness levels to train the model to recognize fullness variations under ideal conditions before real-world deployment. The labeled image dataset T1 for initial model training may use images from an artificial container environment prepared in a lab with diverse waste configurations to establish a baseline AI functionality. Labeled image datasets for model retraining T6, as discussed below, will preferably use human-labeled images from real-world container environments.

In a weighted AI modelling T3, a weighted fusion algorithm is used to make a weighted fullness assessment WF based on multiple individual fullness assessments. In some examples the weighted fullness assessment WF may be calculated based on a first fullness assessment F1 from a first sensor (e.g., an image AI model prediction from a camera 110A) and a second fullness assessment F2 from a second sensor (e.g., an analytical estimation from a ToF sensor 110B) with dynamic weights W1 and W2 assigned to the results of the respective fullness assessments F1 and F2 based on the historic reliability of the corresponding sensors, as determined from an obstruction factor OC (O1) and OT (O2). A discrepancy assessment T4 is made between the fullness assessments F1 and F2 to determine if the results of the separate fullness assessments exceeds a predefined threshold, |F1−F2|>ΔF. In other examples, the weighted fullness assessment WF may be calculated based on a first fullness assessment F1 from a first sensor (e.g., an image AI model prediction from a camera 110A) and a second fullness assessment F2 from a second sensor (e.g., an analytical estimation from a ToF sensor 110B), and a third fullness assessment from a third sensors (e.g., an estimation from a ToF sensor 110C), with normalized dynamic weights W1n, W2n and W3n assigned to the results of the respective fullness assessments F1, F2 and F3 based on the historic reliability of the corresponding sensors, as determined from obstruction factors OC (O1), OT (O2) and OR (O3). A discrepancy assessment T4 is made between the fullness assessments F1, F2 and F3 to determine if the results of the separate fullness assessments exceeds predefined thresholds, |F1−F2| >ΔFa, |F1−F3|≥ ΔFb, and |F2−F3|≥ ΔFc.

When a discrepancy flag is not present (T4, FALSE), the weighted fullness estimate WF generated by the weighted AI modelling T3 are output as a fullness estimate of the container. When a discrepancy flag is present (T4, TRUE), a secondary assessment T5 is made of the weighted AI modelling T3 (e.g., human assessment, AI assessment). The secondary assessment T5 will assign a verified fullness level and output the same as a fullness estimate of the container. The verified fullness level may be a less precise assessment than might otherwise be made by the weighted AI modelling T3, for example, with a human operator assigning only an incremental value of fullness (e.g., 0%, 20%, 40%, 60%, 80%, or 100%). Alternatively, the verified fullness level may be assessed with use of an artificial intelligence (AI) agent, or an interface to an external AI large language model (LLM), that is trained to determine fill level based on image and distance measurements. The secondary assessment T5 may also yield labelled data from the weighted fullness assessment WF, as made by the weighted AI modelling T3, with the labeled data stored for use as verified fullness state data for model re-training of one or both of the image-based AI modelling T2 (substituting for labeled image dataset T1) and/or the weighted AI modelling T3. When retaining the weighted AI modelling T3 with labeled data, the modelling is also retrained with data informing historical performance trends of the respective sensors, historical reliability scores derived from past discrepancies and operator corrections, and historical obstruction factor scores based on verified fullness state data from the secondary assessment T5.

This model training, with use of a self-optimizing feedback loop to update image-based AI modelling T2 and weighted AI modelling T3, based on continuous monitoring of discrepancies and iterative refinement through additional real-world learning cycles, results in increasingly accurate adaptive weight values W1, W2 and W3 for weighted fullness assessments WF, ensuring the inventive system generates content assessments with increasing accuracy over time, while minimizing over-reliance on individual sensors. As the modelling is continuously improved, there is a progressive reduction in occurrence of discrepancy flags and the need for secondary assessments T2.

Systems according to the present invention may enable several advantages over existing systems, including accuracy and reliability with dynamic sensor fusion to ensure precise measurements under varying environmental conditions; proactive maintenance with obstruction factor assessment to reduce downtime by triggering timely alerts for servicing; energy efficiency with a similarity assessment to minimize unnecessary wireless communication and extend battery life; comprehensive data analysis, with multiple overlapping sensors (e.g., three different cameras in three different sensor groupings) to provide comprehensive assessments of container contents from multiple perspectives; multi-tiered content analysis, including identification of container fill levels with high accuracy and identification of container content types, for example, to identify recycling contamination, material classification, and the like; and scalable AI training that combines automated processes with human oversight for continuous improvement.

The foregoing disclosure discussed systems according to the present invention as they may be deployed in the context of waste management, for example, to monitor and report on the fullness state of a waste dumpster for using in scheduling and effecting waste removal. This is a non-limiting example, and systems according to the present invention may be used for other purposes.

Systems according to the present invention may be used to monitor material levels in containers of any type; visually verify inventory in containers or on shelves, and to detect circumstances of inventory absence (e.g., out-of-stock) and/or misplacement; optimize HVAC, lighting, and security systems, for example, by detecting occupancy and count of persons in a defined space, where the defined space may be a room in a building or a public setting that is treated as the “container” in which a sensor device according to the present invention is deployed; identify underutilized areas and optimize layouts, for example, by combining occupancy data and distance measurements within a defined space; and monitor queue lengths and optimize customer service and/or staffing.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

It will be understood, for aspects of the present invention described herein with reference to flowchart illustrations and/or block diagrams of methods, apparatus (systems), and computer program products, that each block of a flowchart illustration and/or block diagram, and combinations of blocks in flowchart illustrations and/or block diagrams, may be implemented by computer readable program instructions. Flowcharts and block diagrams in the figures illustrate architecture, functionality, and operation of possible implementations of systems, methods, and devices according to examples of the present invention. Each block in the flowchart or block diagrams may represent a module, segment, or portion of instructions, which comprises one or more executable instructions for implementing specified logical function(s). In some implementations, the functions noted in the blocks may occur in an order other than that expressed in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

What is claimed is:

1. A system for determining a fullness state of a container, comprising:
a sensor device comprising one or more content sensors, a processor, memory accessible by the processor, program instructions and data stored in the memory, and a network adapter;
wherein the one or more content sensors are configured for collecting data informative of a fullness state of a container;
wherein the network adapter is configured for transmitting data collected by the one or more content sensors to a network for delivery to a server; and
wherein the processor is configured to:
collect data informative of a current fullness state of a container via the one or more content sensors;
execute a similarity analysis comparing the collected data informative of the current fullness state of the container and data stored in the memory informative of a prior fullness state of the container, wherein
if there is determined a difference between the current fullness state of the container and the prior fullness state of the container in excess of a threshold amount, transmit the collected data informative of the current fullness state of the container to the network via the network adapter; and
if there is determined a difference between the current fullness state of the container and the prior fullness state of the container not in excess of a threshold amount, forgo transmission of the collected data informative of the current fullness state of the container.

2. The system according to claim 1, wherein
the one or more content sensors comprise one or more sensors chosen from: a camera; a time-of-flight sensor; and a radar sensor.

3. The system according to claim 1, wherein
the processor is configured to collect data informative of a current fullness state of a container via the one or more content sensors upon receiving a trigger signal for triggering data collection.

4. The system according to claim 3, wherein
the processor is configured to receive trigger signals from programmed instructions stored at the memory that are configured to trigger data collection by the one or more content sensors on a predetermined schedule.

5. The system according to claim 3, wherein
the sensor device further comprises one or more trigger sensors configured to output a trigger signal to the processor upon detecting a trigger event.

6. The system according to claim 5, wherein
the one or more trigger sensors comprise one or more sensors chosen from: a magnetometer;
an ambient light sensor; and a temperature sensor.

7. The system according to claim 5, wherein
the processor is further configured to:
when collecting data informative of a current fullness state of a container via the one or more content sensors, determine if that data collection was performed based on receipt of a trigger signal from a trigger sensor; and
if the data informative of a current fullness state of a container was collected not on the basis of receipt of a trigger signal from a trigger sensor, execute the similarity analysis; and
if the data informative of a current fullness state of a container was collected on the basis of receipt of a trigger signal from a trigger sensor, forgo the similarity analysis and transmit the collected data informative of the current fullness state of the container to the network via the network adapter.

8. The system according to claim 1, wherein
the processor is configured to execute a similarity analysis comprising one or more analyses chosen from: a pixel-wise difference analysis; an image down sampling & mean brightness difference analysis; a histogram-based comparison; and an edge detection & structural comparison.

9. The system according to claim 1, wherein
the processor is further configured to update data stored in the memory to record the collected data informative of the current fullness state of the container for use in future similarity analyses as data informative of a prior fullness state of the container.

10. A system for determining a fullness state of a container, comprising:
a processor, memory accessible by the processor, program instructions and data stored in the memory, the processor being configured to:
generate a first fullness estimate of the container based on first content data informative of a fullness state of the container, as collected by a first content sensor;
generate a second fullness estimate of the container based on second content data informative of a fullness state of the container, as collected by a second content sensor;
generate a weighted fullness estimate of the container as a weighted function of the first fullness estimate and the second fullness estimate, in which the first fullness estimate is assigned a first weight and the second fullness estimate is assigned a second weight.

11. The system according to claim 10, wherein
the processor is further configured to:
generate a first obstruction factor representing reliability of the first content sensor;
generate a second obstruction factor representing reliability of the second content sensor;
calculate the first weight assigned to the first fullness estimate based on the first obstruction factor; and
calculate the second weight assigned to the second fullness estimate based on the second obstruction factor.

12. The system according to claim 11, wherein
the processor is further configured to:
generate the first fullness estimate based on first content data collected by a cameras as the first content sensor;
generate the second fullness estimate based on second content data collected by a time-of-flight sensor as the second content sensor;
generate the first obstruction factor representing a reliability of the camera by analyzing the quality and consistency of image data captured by the camera via one or more analyses chosen from: blur detection; dynamic region analysis; and occlusion coverage estimation; and
generate the second obstruction factor representing a reliability of the time-of-flight sensor by analyzing distance captured by the time-of-flight sensor via one or more analyses chosen from: an invalid measurement ratio analysis; a static distance pattern analysis; and a depth variance analysis.

13. The system according to claim 10, wherein
the processor is further configured to:
generate a first historical confidence factor representing historical confidence of the first content sensor in yielding accurate fullness estimates;
generate a second historical confidence factor representing historical confidence of the second content sensor in yielding accurate fullness estimates;
calculate the first weight assigned to the first fullness estimate based on the first historical confidence factor; and
calculate the second weight assigned to the second fullness estimate based on the second historical confidence factor.

14. The system according to claim 10, wherein
the processor is configured to generate the weighted fullness estimate of the container based on the following functions:
$$WF = W 1 n \cdot F 1 + W 2 n \cdot F 2$$
$$W 1 n = \frac{W 1}{( W 1 + W 2 )}$$
$$W 2 n = \frac{W 2}{( W 1 + W 2 )}$$
$$W 1 = \frac{( 1 - O 1 ) \cdot H 1}{( 2 - O 1 - O 2 )}$$
$$W 2 = \frac{( 1 - O 2 ) \cdot H 2}{( 2 - O 1 - O 2 )}$$
wherein the weighted fullness estimate (WF) is generated as a weighted function of the first fullness estimate (F1) and the second fullness estimate (F2);
wherein a first weight (W1) assigned to the first fullness estimate (F1) is calculated as a function of a first obstruction factor (O1) generated relative to the first content sensor, a second obstruction factor (O2) generated relative to the second content sensor, and a first historical confidence factor representing historical confidence of the first content sensor; and
wherein a second weight (W2) assigned to the second fullness estimate (F2) is calculated as a function of the first obstruction factor (O1) generated relative to the first content sensor, the second obstruction factor (O2) generated relative to the second content sensor, and a second historical confidence factor representing historical confidence of the second content sensor.

15. The system according to claim 10, wherein
the processor is further configured to determine a difference between the first fullness assessment and the second fullness assessment and, if the difference exceeds a predetermined threshold difference, generate a discrepancy flag.

16. The system according to claim 10, wherein
the processor is further configured to:
generate a third fullness estimate of the container based on third content data informative of a fullness state of the container, as collected by a third content sensor;
generate the weighted fullness estimate of the container as a weighted function of the first fullness estimate, the second fullness estimate and the third fullness estimate, in which the third fullness estimate is assigned a third weight.

17. The system according to claim 16, wherein
the processor is further configured to:
generate a first obstruction factor representing reliability of the first content sensor;
generate a second obstruction factor representing reliability of the second content sensor;
generate a third obstruction factor representing reliability of the third content sensor;
calculate the first weight assigned to the first fullness estimate based on the first obstruction factor;
calculate the second weight assigned to the second fullness estimate based on the second obstruction factor; and
calculate the third weight assigned to the third fullness estimate based on the third obstruction factor.

18. The system according to claim 16, wherein
the processor is further configured to:
generate a first historical confidence factor representing historical confidence of the first content sensor in yielding accurate fullness estimates;
generate a second historical confidence factor representing historical confidence of the second content sensor in yielding accurate fullness estimates;
generate a third historical confidence factor representing historical confidence of the third content sensor in yielding accurate fullness estimates;
calculate the first weight assigned to the first fullness estimate based on the first historical confidence factor;
calculate the second weight assigned to the second fullness estimate based on the second historical confidence factor; and
calculate the third weight assigned to the third fullness estimate based on the third historical confidence factor.

19. The system according to claim 16, wherein
the processor is configured to generate the weighted fullness estimate of the container based on the following functions:
$$WF = W 1 n \cdot F 1 + W 2 n \cdot F 2 + W 3 n \cdot F 3$$
$$W 1 n = \frac{W 1}{( W 1 + W 2 + W 3 )}$$
$$W 2 n = \frac{W 2}{( W 1 + W 2 + W 3 )}$$
$$W 3 n = \frac{W 3}{( W 1 + W 2 + W 3 )}$$
$$W 1 = \frac{( 1 - OC ) \cdot H 1}{( 3 - OC - OT - OR )}$$
$$W 2 = \frac{( 1 - OT ) \cdot H 2}{( 3 - OC - OT - OR )}$$
$$W 3 = \frac{( 1 - OR ) \cdot H 3}{( 3 - OC - OT - OR )}$$
wherein the weighted fullness estimate (WF) is generated as a weighted function of the first fullness estimate (F1), the second fullness estimate (F2), and the third fullness estimate F3;
wherein a first weight (W1) assigned to the first fullness estimate (F1) is calculated as a function of a first obstruction factor (O1) generated relative to the first content sensor, a second obstruction factor (O2) generated relative to the second content sensor, a third obstruction factor (O3) generated relative to the third content sensor, and a first historical confidence factor representing historical confidence of the first content sensor;
wherein a second weight (W2) assigned to the second fullness estimate (F2) is calculated as a function of the first obstruction factor (O1) generated relative to the first content sensor, the second obstruction factor (O2) generated relative to the second content sensor, the third obstruction factor (O2) generated relative to the third content sensor, and a second historical confidence factor representing historical confidence of the second content sensor; and
wherein a third weight (W3) assigned to the third fullness estimate (F3) is calculated as a function of the first obstruction factor (O1) generated relative to the first content sensor, the second obstruction factor (O2) generated relative to the second content sensor, a third obstruction factor (O3) generated relative to the third content sensor, and a third historical confidence factor representing historical confidence of the third content sensor.

20. The system according to claim 16, wherein
the processor is further configured to determine differences between at least two of the first fullness assessment, the second fullness assessment, and the third fullness assessment and, if the difference exceeds a predetermined threshold difference, generate a discrepancy flag.
